(19) United States
(12) Patent Application Publication
(10) Pub. No.: US 2002/0147983 A1
(43) Pub. Date: Oct. 10, 2002

(54) Television system and method for communication notification

(75) Inventors: Erez Michael, Petach-Tiqwa (IL); Shlomi Kringel, Tel-Aviv (IL)

Correspondence Address: SUGHRUE, MION, ZINN, MACPEAK & SEAS, PLLC, 2100 Pennsylvania Avenue, N.W., Washington, DC, 20037-3213, US

(73) Assignee: COMVERSE NETWORK SYSTEMS, LTD.

(21) Appl. No.: 09/917,896

(22) Filed: Jul. 31, 2001

Related U.S. Application Data
(60) Provisional application No. 60/281,721, filed on Apr. 6, 2001.

(51) Int. Cl. H04N 7/173

(52) U.S. Cl. 725/106; 725/122

(57) ABSTRACT

A system and method for providing signals to television receivers (60) of selected users within a television network (30) is disclosed. The system comprises an intercept unit (130) connected to a telephone network (110). The intercept unit (130) is arranged to obtain data on a telephone call being made to a user's telephone number and to communicate the data to the receiver (60) of the user. The receiver (60) is arranged to display the data on an associated television screen (70).

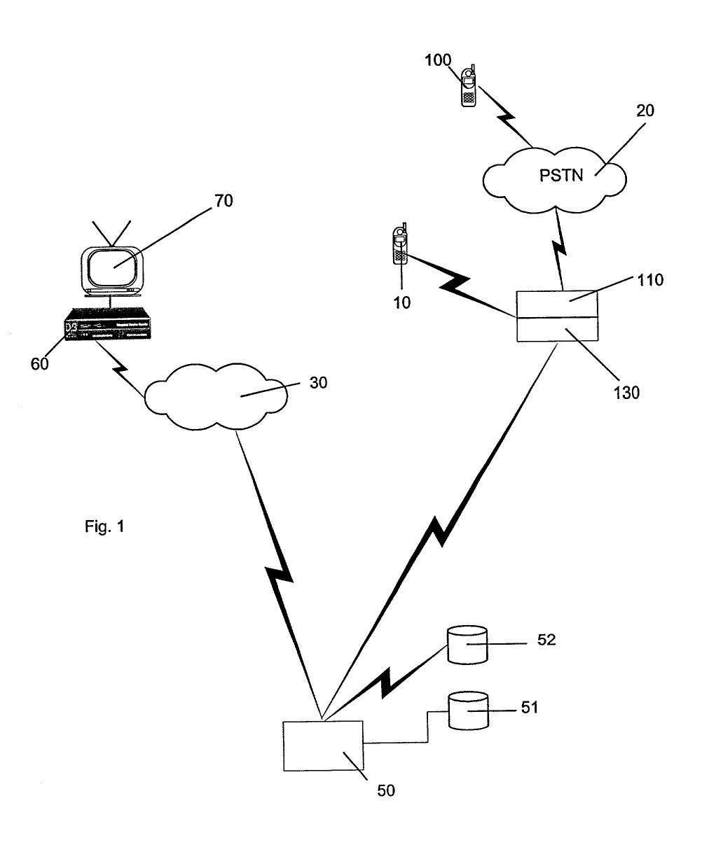

### CROSS-REFERENCE TO OTHER APPLICATIONS

This application claims the benefit of U.S. Provisional Application No. 60/281,721 filed Apr. 6, 2001. Application No. 60/281,721 is incorporated herein by reference in its entirety.

### BACKGROUND

1. Technical Field

The description relates to a system for use with television systems allowing notification and management of incoming telephone calls via a television set.

2. Related Work

Developments in telephone systems now allow an incoming call's calling line indicator (CLI) to be displayed on a handset or on a screen associated with a telephone so that a user can screen calls and decide whether to answer them. This has been further extended by allowing different ring tones to be associated with different CLI's and also for names to be associated with CLI's.

To capture CLI's of incoming calls, a device in, or connected to, the telephone apparatus at a user's premises scans the signals of incoming telephone calls and obtains the CLI from the incoming signal. This is then displayed to the user on a display by the telephone. U.S. Pat. Nos. 6,049,713 and 5,553,125 discuss such an arrangement. These patents are herein incorporated by reference for their useful background information on caller identification.

However, such arrangements require a user to stop whatever it is that he or she is doing and go to the telephone or device to decide whether to answer the call based on the CLI or other indication. Furthermore, they require the purchase and installation of specific equipment and/or telephone apparatus.

### SUMMARY OF THE INVENTION

One object of the present invention, among others that will become apparent from the discussion below, is to provide a CLI or other indication of a caller to a user's television set. In one preferred embodiment, this is accomplished without any addition to existing equipment at a user's premises.

In one preferred embodiment, the above object is achieved by installing an intercept unit at a switch or an exchange within the telephone network that serves the user. When an incoming telephone call directed to the user's telephone number is detected, the intercept unit obtains the CLI or other caller data and transmits this to a digital television decoder or other similar receiver within the user's house for display on a user's television. In this manner, a user watching television can decide whether to answer the phone or let voicemail take the call. Further functionality may be offered by allowing the user to use a remote control or the like to redirect the call to voicemail, another telephone or to send an instant message or email in reply to the call.

### BRIEF DESCRIPTION OF THE DRAWING FIGURE

The sole FIGURE is a simplified schematic diagram showing a television system that achieves the aforementioned object.

### DETAILED DESCRIPTION OF THE PREFERRED EMBODIMENTS

Using the above-identified FIGURE, the invention will now be described with respect to various preferred embodiments. Although many specificities will be mentioned, it must be emphasized that the scope of the invention is not be taken to be that of only the preferred embodiments, but should be construed in accordance with the claims appended below.

Prior to describing in detail the preferred embodiments, however, certain terms will now be defined for the purposes of this description.

Computer System

One embodiment of this invention resides in a computer system. Here, the term “computer system” is to be understood to include at least a memory and a processor. In general, the memory will store, at one time or another, at least portions of an executable program code, and the processor will execute more or one of the instructions included in that executable program code. It will be appreciated that the term “executable program code” and the term “software” means substantially the same thing for the purposes of this description.

Under this definition, “computer system” encompasses not only the more traditional notions of a computer, but also various other processor-enabled devices such as a television system, a set-top-box, an application specific integrated circuit, or the like.

Computer Program Product

The above-identified invention may be embodied in a computer program product, as will now be explained.

On a practical level, the software that enables the computer system to perform the operations described further below in detail, may be supplied on any one of a variety of media. Furthermore, the actual implementation of the approach and operations of the invention are actually statements written in a programming language. Such programming language statements, when executed by a computer, cause the computer to act in accordance with the particular content of the statements. Furthermore the software that enables a computer system to act in accordance with the described system may provide in a number of forms, including, but not limited to, original source code, assembly code, object code, machine language, encrypted or compressed versions of the foregoing and any and all equivalents.

One of skill in the art will appreciate that “media”, or “computer readable media”, as used here, may include a diskette, a tape, a compact disc, an integrated circuit, a ROM, a CD, a cartridge, a memory stick, a remote transmission via a communication circuit, or any other similar medium usable by computers, even those media hereafter developed. For example, to supply software for enabling a computer system to operate in accordance with the system described herein, the supplier may provide a CD or transmit the software in some form via satellite transmission, via a direct telephone link, via a cable, or via the Internet. Thus, the term “computer readable medium” is intended to include all of the foregoing and any other medium by which computer software may be provided to a computer system.

Although the enabling software may be “written on” a diskette, “stored in” an integrated circuit, “carried over” a communication circuit or “downloaded” via the Internet, it will be appreciated that for the purposes of this description, the software will be referred to as being “on” the computer readable medium. The term “on” may not linguistically be a perfect fit for ever possible combination of software and computer readable medium, but it will be appreciated that the term is one of linguistic convenience. Thus, the term “on” is intended to encompass the above and all equivalent ways in which software is associated with a computer readable medium.

For the sake of simplicity, therefore, the term “computer program product” is thus used to refer to a computer readable medium, as defined above, which has on it any form of software to enable a computer system to operate according to certain pre-defined steps.

User Interface

A user interface may be understood to mean any hardware, software, or combination of hardware and software that allows a user to interact with a computer system. For the purposes of this description, a user interface will be understood to include one or more user interface objects. User interface objects may include display regions, user activatable regions and the like.

As is well understood, a display region is a region of a user interface which displays information to the user. A user activatable region is a region of a user interface such as a button or menu, which allows the user to take some action with respect to the user interface.

A user interface may be invoked by an application program. Another application program invokes user interface, it is typically for the purpose of interacting with a user. It is not necessary, however, for the purposes of this description, that an actual user ever interacts with the user interface. It is also not necessary, for the purposes of this description, that the interaction with the user interface be performed by an actual user. That is to say, it is foreseen that the user interface may have interaction with another program, such as a program created using macro programming language statements that simulate the actions of a user with respect of the user interface.

First Embodiment

With the foregoing definitions in mind, an exemplary embodiment of the invention will now be described.

A user owns a telephone 10 subscribed to a telephone network 20. The telephone 10 has an associated telephone number that others enter to call the user's telephone 10. The user is also a subscriber to a digital television network 30. The digital television network 30 is in communication with a service transmission system 50. The service transmission system is preferably located at the head-end of the television operator and acts as an intermediary for communications between the television network 30 and the telephone network 20.

The term “television network” used herein refers to a television broadcast network which is responsible for the actual transmission of television signals to a television receiver of a user. Examples of a television broadcast network include a cable television distribution system, a terrestrial television broadcast network, a satellite television distribution system.

A person, who is typically someone wishing to contact the user and who may be referred to as a distant party, for the sake of convenience, uses his telephone 100 to call the telephone 10 of the user. The call is passed over the telephone network 20 to a telephone system 110 typically operated by the user's telephone service provider. The telephone system 110 is the interface that connects the user's telephone 10 to the telephone network and is typically a switch at a telephone exchange (also known as a central office).

An interception system 130 (described in detail below) is connected to the telephone system 110 to monitor calls received by the telephone system 110 and to detect calls directed to the telephone number of the user's telephone 10. Upon detection of such a call, the interception system 130 obtains the CLI of the incoming call and transmits this to the service transmission system 50 along with the telephone number of the user's telephone 10. The service transmission system 50 determines the identity of the decoder or set-top-box 60 at the user's location from a database 55 that cross-references telephone numbers with set-top-box ID's. The database 55 is maintained by the operator of the service transmission system 50 and/or the operator(s) of the telephone network 20 and/or the television network 30. Each user's telephone number is obtained from the user or telephone network operator. The unique ID for the user's set-top-box is typically obtained from the television network operator.

The service transmission system 50 transmits a signal (referred to herein as an incoming call indication signal) over the television network 30 to the set-top-box 60 (addressed using the unique ID of the set-top-box 60) indicating the CLI of the incoming call. Upon receipt of the incoming call indication signal, the set-top-box 60 displays an appropriate signal or message on the user's television 70.

The appropriate signal or message may take various forms, but it will be appreciated that, for the sake of generality, the term “incoming call indication” as used herein refers to any indication displayed on a television screen indicating information about an incoming call. Armed with this incoming call indication, the user can easily choose whether to answer the telephone 10 without having to actually consult the telephone equipment itself.

The incoming call indication signal may be embedded within a television program signal for direct display on the television 70 without processing by the set-top-box 60. It also may be a separate signal addressed to a specific software application running on the set-top box 60 or portion of the operating system of the set-top-box 60 that displays an additional window over the current television program displayed on the television.

The incoming call indication signal may also be displayed by the set-top-box 60 as a message superimposed over the current television program.

To put it another way, a user interface is provided and is responsive to an incoming call indication signal to provide a display region on the television that includes an incoming call indication based on the incoming call indication signal.

Preferably, the interception system 130 communicates with SS7 (Signalling System 7) or IN (Intelligent Network) components of the telephone system 110 or any other component that holds the CLI in real-time. Alternatives include communication with a telephone operator's real-time billing system, a follow-me system or any other system that holds a real-time caller ID. The interception system 130 communicates this with the service transmission system 50 that is preferably located at the head-end of the digital television system in order for the information to be forwarded to the subscriber decoder in real time. Such communication between the interception system 130 and the service transmission system 50 may be via the Internet, a dedicated telephone line, or any other available public or private data communication channel.

The service transmission system 50 or the interception system 130 may maintain a log file of the CLI's of received calls along with details of time, call duration and whether the call was answered, routed to voicemail or other outcome of the call. It will be appreciated, however, that the log file need not include all of the information just mentioned, and may also include other information not described here in this example. For the sake of generality and simplicity, the log file may be thought of and referred to herein as “prior call information”. The prior call information may be made accessible to a user at the television 70 making an appropriate request from the set-top-box 60, which may be referred to as a prior call information access request. The set-top-box 60 communicates with the service transmission system 50 to obtain the log from the system 50 or the interception system 130. A suitable module within the set-top-box 60 receives the log file (in what may be referred to as a prior call information signal), or selected portions, and displays it or the selected portions, to the user on the television 70.

For example, the user interface may include an object that responds to the receipt of a prior call information signal by providing a display region including prior call information. Furthermore, the user interface may include a user activatable region for sending a prior call information access request.

The system can support wireless and conventional wireline telephone systems and can be applied to cable television, satellite television, digital terrestrial television or any other sort of television network in which a signal can be directed to a specific receiver. A database 51 may be maintained at the service transmission system 50 associating names and other data, such as photographs, with known CLI's so that this data replaces or adds to the CLI indication displayed on the user's television. Furthermore, a telephone operator's database 52 may be accessed by the service transmission system 50 or the intercept system 130 to obtain this data.

To put it another way, the CLI may be thought of as system-provided incoming call information. The associated names and other data (non-limiting examples of which are provided above) may be thought of as supplemental incoming call information or also as “further data”. It will be appreciated that in the exemplary embodiment now being described, the incoming call indication signal comprises of not only system-provided incoming call information, but also supplemental incoming call information. Likewise, the user interface in this instance provided a display region for displaying the supplemental incoming call information.

Communication from the decoder or set-top-box 60 to the service transmission system 50 and in turn to the telephone system 110 may be used to direct the incoming calls to another telephone, voicemail or some other system.

For example, when the CLI indication is displayed on the user's television, the set-top-box 60 may display one or more call management options on screen. Using the set-top-box's remote control, the user can select one of the options such as: redirect to voicemail or send a message to caller saying “call me later”. Alternatively, specific buttons or command sequences within the remote control may correspond to such options removing the requirement for extra controls or data on the television screen.

Once an option is selected and received by the set-top-box 60, the set-top-box 60 sends a call management message indicating the option selected to the service transmission system 50.

It will be appreciated that the call management functions described can be realised in the user interface by way of user activatable regions. The call management functions described are exemplary, and many others may occur to those of some familiarity with this technology. It will also be appreciated that the user interface responds to the activation of a user activatable region for call management by taking a responding call management action, such as sending a call management communication message to the service transmission system 50.

Where the digital television network 30 does not allow two-way communication, such as in the case of digital terrestrial television and digital satellite television, another communication network such as PSTN, SMS, GSM, UTMS, GPRS may be used by the set-top-box 60 to contact the service transmission system 50.

This other network connection can be a dial-up connection, such as one established on an as-needed basis, or a permanent or semi-permanent connection, such as a DSL or private network connection.

Upon receiving a call management message, the service transmission system 50 determines the user's telephone number from the database 55 and communicates with the interception system 130 to control the rerouting of the call to another system such as a voicemail system. Alternatively, the service transmission system 50 may request an email or messaging system to send a communication to the caller.

The invention has been described in general terms, and in very specific terms with retrospect to particular exemplary embodiments. The invention is not limited to these examples, and the scope of the invention is to be determined in accordance with the appended claims.

It will be appreciated that, although the thrust of the examples has been in the home environment, other scenarios are possible. That is to say, that it is is easy to generalise from the present set of exemplary embodiments from the home environment to an office environment in which telephones are typically used in close proximity to display units of networked computers. Thus, the telephone system of a business could similarly be monitored by a server on the business' network and incoming call information could be provided on the display of a network user by a pop-up window or the like. Such incoming call information could of course include not only the system-provided information but also supplemental information as mentioned above.

Furthermore, with the advent of home users connecting their computers to the Internet via cable modems and the like, incoming call indication could also be displayed on the home computer display of the user.

Likewise, although the set-top-box has been described as being separate from the television display, it could also easily be integrated within a television such as in the case of integrated digital televisions. It will also be understood that the software instructions for permitting a set-top-box, service transmission system, telephone system, or other computer system to operate according to the invention may be supplied using a computer program product as defined above.

The problems solved above relate to the home environment, but the solution to the problems with the convenient access to incoming call information could be applied to other areas as well, even factory environments.

The present system and invention are applicable to all types of television decoders, including integrated televisions and set-top-boxes. Furthermore, the system described herein, is simpler at least in terms of installation at the users premises, than prior CLI systems because no additional equipment is required to be installed or maintained at a users premises.

Other variations will occur to those familiar with this field, and may be made without departing from the scope and spirit of the invention.

There is claimed:

1. A system for providing signals to a television receiver of a user within a television network, the system comprising: an intercept unit connected to a telephone network and obtaining data concerning a telephone call being made to a user's telephone number, communicating the data over the television network to the television receiver of the user, wherein the television receiver of the user displays the data concerning the telephone call on a television screen associated with the television receiver of the user.

2. A system according to claim 1, further comprising:
a service transmission system communicating with the television network;
the intercept unit communicating the data concerning the telephone call to the service transmission system; and,
the service transmission system formatting the data into a television signal and communicating the television signal over the television network to the television receiver of the user.

3. A system according to claim 2, in which the intercept unit communicates data to the service transmission system via one of the Internet and a telecommunications network.

4. A system according to claim 2, further comprising a database cross-referencing user telephone numbers with data on the television receiver of the user; the intercept unit communicating the telephone number of the user to the service transmission system; and the service transmission system accessing the database to obtain the data on the television receiver of the user, and using the data on the television receiver of the user to communicate the television signal to the television receiver of the user.

5. A system according to claim 2, wherein the service transmission system embeds the data concerning the telephone call within a television program to be broadcast to the television receiver of the user, the data concerning the telephone call being displayed within the television program on the television screen of the user.

6. A system according claim 2, wherein the service transmission system communicates the television signal to the user's television receiver separately to broadcasts of television programs, the user's television receiver displaying the data concerning the telephone call over any displayed television program displayed on the television screen.

7. A system according to claim 2, wherein the data concerning a telephone call includes a caller's calling line indicator.

8. A system according to claim 2, wherein the intercept unit obtains further data on a caller in dependence on the obtained data concerning the telephone call and communicates the data concerning the telephone call and the further data to the service transmission system for communication to the user's television receiver.

9. A system according to claim 2, wherein the service transmission system obtains further data on a caller in dependence on the data concerning the telephone call communicated by the intercept unit and formats the data concerning the telephone call and the further data into a television signal for communication to the user's television receiver.

10. A system according to claim 2, wherein the service transmission system obtains further data on a caller in dependence on the data concerning the telephone call communicated by the intercept unit and replaces the data concerning the telephone call with the further data prior to formatting the data into a television signal for communication to the user's television receiver.

11. A system according to claim 9, further comprising a database of information on known callers, the service transmission system obtaining the further data from the database of information on known callers.

12. A system according to claim 9, wherein the service transmission system communicates with a telephone service provider's database and obtains the further data from the telephone service provider's database.

13. A system according to claim 2, wherein the receiver accepts an input from a user in response to the data displayed on the television screen and communicates the input to the service transmission system, the service transmission system managing the call in dependence on the input.

14. A system according to claim 13, wherein the input is a command to redirect to a voicemail system, the service transmission system communicating with the intercept unit to redirect the call to the voicemail system.

15. A system according to claim 13, wherein the input is a command to send a message to a caller, the service transmission system communicating with a messaging system to send the message to the caller.

16. A system according to claim 15, wherein the message is one of: an instant message or an email.

17. A system according to claim 1, wherein the television receiver is a digital television decoder.

18. A system according to claim 17, wherein the decoder is a set-top-box.

19. A method of providing signals to television receivers of selected users within a television network, the method comprising:
obtaining data at a telephone system on telephone calls being made to a user's telephone number;
communicating the data over the television network to the television receiver of the user; and,
displaying the data on an associated television screen.

20. A method according to claim 19, in which the step of communicating the data further comprises formatting the data into a television signal and communicating the television signal across the television network to the television receiver of the user.

21. A method according to claim 20, further comprising the step of cross-referencing the user's telephone number with data on the television receiver of the user, wherein the step of communicating the television signal to the television receiver further comprises the step of communicating the television signal to the television receiver of the user using the data on the receiver.

22. A method according to claim 20, wherein the step of formatting the data into a television signal comprises the step of embedding the data within a television program to be broadcast to the television receiver of the user.

23. A method according to claim 20, further comprising the steps of obtaining further data on a caller in dependence on the obtained data and formatting the data and the further data into a television signal for communication to the receiver.

24. A method according to claim 20, further comprising the steps of obtaining further data on a caller in dependence on the obtained data, discarding the data and formatting the further data into a television signal for communication to the receiver.

25. A method according to claim 23, further comprising the step of maintaining a database of information on known callers, wherein the step of obtaining further data comprises the step of obtaining further data from the database of information on known callers.

26. A method according to claim 23, wherein the step of obtaining further data comprises the steps of accessing a telephone service provider's database and obtaining the further data from the telephone service provider's database.

27. A method according to claim 19, further comprising the steps of accepting an input from a user in response to the data displayed on the television screen and managing the call in dependence on the input.

28. A method according to claim 27, wherein the step of managing comprises at least one of the steps of:
redirecting the call to a voicemail system, sending an instant message to the caller or sending an email to the caller.

29. A computer program product for supporting improved incoming call indications, comprising software instructions on a computer readable medium, the software instructions being adapted to enable computer systems to operate according to a method comprising:
obtaining data at a telephone system on telephone calls being made to a user's telephone number;
communicating the data over the television network to the receiver of the user; and,
displaying the data on an associated television screen.

30. A computer program product comprising software instructions on a computer readable medium, the instructions enabling a system of computers to provide signals to televisions of selected users within a television network, and comprising instructions for:
enabling a computer to obtain data at a telephone system on telephone calls being made to a user's telephone number;
enabling the computer to communicate the data to a receiver of the user; and,
enabling the receiver to display the data on an associated television screen.

31. A computer program product according to claim 29, in which the instructions for enabling the computer to communicate the data further comprises instructions for enabling the computer to format the data into a television signal and instructions for enabling the computer to communicate the television signal across the television network to the receiver of the user.

32. A computer program product according to claim 30, further comprising instructions for enabling the computer to cross-reference the user's telephone number with data on the receiver of the user, wherein the instructions for enabling the computer to communicate the television signal to the receiver further uses the data on the receiver.

33. A computer program product according to claim 31, wherein the instructions for enabling the computer to format the data into a television signal embeds the data within a television program to be broadcast to the receiver of the user.

34. A computer program product according to claim 31, further comprising instructions for enabling the computer to obtain further data on a caller in dependence on the obtained data, wherein the instructions for enabling the computer to format the data formats the data and the further data into a television signal for communication to the receiver.

35. A computer program product according to claim 31, further comprising instructions for enabling the computer to obtain further data on a caller in dependence on the obtained data, wherein the instructions for enabling the computer to format the data discard the data and format the further data into a television signal for communication to the receiver.

36. A computer program product according to claim 31, further comprising instructions for enabling the computer to maintain a database of information on known callers, wherein the device for enabling the computer to obtain further data obtains the further data from the database.

37. A computer program product according to claim 31, wherein the device for enabling the computer to obtain further information accesses a telephone service provider's database to obtain the further data.

38. A computer program product according to claim 30, further comprising a device for enabling the receiver to accept an input from a user in response to the data displayed on the television screen and a device for enabling the computer to manage the call in dependence on the input.

39. A user interface for a television, comprising:
an object for receiving an incoming telephone call indication signal; and
a display region, responsive to said incoming telephone call indication signal, displaying an incoming telephone call indication based on said incoming telephone call indication signal.

40. The user interface as set forth in claim 39, further comprising a user activatable region for sending a prior call information access request.

41. The user interface as set fourth in claim 40, further comprising:
an object for receiving a prior call information signal; and
a display region displaying prior call information based on said prior call information signal.

42. The interface as set fourth in claim 39, wherein the incoming call indication signal comprises system-provided incoming call information and supplemental incoming call information.

43. The interface as set fourth in claim 42, further comprising a display region displaying said supplemental incoming call information.

44. The interface as set fourth in claim 39, further comprising a user activatable region for indicating a call management function relating to incoming telephone calls of said user.
